(19) United States
(12) Patent Application Publication
(10) Pub. No.: US 2017/0201878 A1
(43) Pub. Date: Jul. 13, 2017

(54) METHOD AND APPARATUS FOR SAFE NETWORK ACCESS POINT DETECTION

(71) Applicant: Intel Corporation, Santa Clara, CA (US)

(72) Inventors: Yun Yu, Shanghai (CN); Jun Zhang, Shanghai (CN)

(21) Appl. No.: 13/996,879

(22) PCT Filed: Oct. 29, 2012
(86) PCT No.: PCT/CN12/83649

§ 371 Date: Jun. 21, 2013

(51) Int. Cl. H04W 12/06; H04W 48/16; H04L 9/32

(52) U.S. Cl. CPC H04W 12/06; H04L 9/3268; H04W 48/16; H04L 63/0823

(57) ABSTRACT

An approach is provided for determining the authenticity of an available wireless network access point. The approach involves detecting one or more available wireless network access points. The approach also involves communicating one or more authentication requests to each of the available wireless network access points requesting a corresponding access point certificate. The approach further involves processing one or more of one or more received root certificates, one or more received certificate revocation lists, and one or more received access point certificates, the one or more access point certificates being received in response to the one or more authentication requests, to determine an authenticity status of each of the one or more available wireless network access points. The approach additionally involves displaying a list of the one or more available wireless network access points and the authenticity status of each of the one or more available wireless network access points.

### BACKGROUND

Service providers and device manufacturers (e.g., wireless, cellular, etc.) are continually challenged to deliver value and convenience to consumers by, for example, providing compelling network services. Users of various mobile devices such as mobile phones, tablets, computers, etc. often access the internet using publicly accessible Wireless Fidelity (WiFi) access points. Public wireless network access points are often associated with a name that may indicate a location or owner. Users often can only recognize a public access point by its name. However, it has become common practice for malicious individuals such as hackers to provide misleading wireless network access points to which an unsuspecting user may connect their device. Once connected to a misleading wireless network access point, a user's personal information may be at risk.

### SOME EXAMPLE EMBODIMENTS

Therefore, there is a need for an approach to determine the authenticity of an available wireless network access point.

According to one embodiment, a method comprises causing, at least in part, a detection of one or more available wireless network access points. The method also comprises causing, at least in part, one or more authentication requests to be communicated to each of the one or more available wireless network access points requesting a corresponding access point certificate. The method further comprises processing one or more of one or more received root certificates, one or more received certificate revocation lists, and one or more received access point certificates, the one or more access point certificates being received in response to the one or more authentication requests, to determine an authenticity status of each of the one or more available wireless network access points. The method additionally comprises causing, at least in part, a list of the one or more available wireless network access points and the authenticity status of each of the one or more available wireless network access points to be displayed.

According to another embodiment, an apparatus comprises at least one processor, and at least one memory including computer program code for one or more computer programs, the at least one memory and the computer program code configured to, with the at least one processor, cause, at least in part, the apparatus to cause, at least in part, a detection of one or more available wireless network access points. The apparatus is also caused to cause, at least in part, one or more authentication requests to be communicated to each of the one or more available wireless network access points requesting a corresponding access point certificate. The apparatus is further caused to process one or more of one or more received root certificates, one or more received certificate revocation lists, and one or more received access point certificates, the one or more access point certificates being received in response to the one or more authentication requests, to determine an authenticity status of each of the one or more available wireless network access points. The apparatus is additionally caused to cause, at least in part, a list of the one or more available wireless network access points and the authenticity status of each of the one or more available wireless network access points to be displayed.

According to another embodiment, a computer-readable storage medium carries one or more sequences of one or more instructions which, when executed by one or more processors, cause, at least in part, an apparatus to cause, at least in part, a detection of one or more available wireless network access points. The apparatus is also caused to cause, at least in part, one or more authentication requests to be communicated to each of the one or more available wireless network access points requesting a corresponding access point certificate. The apparatus is further caused to process one or more of one or more received root certificates, one or more received certificate revocation lists, and one or more received access point certificates, the one or more access point certificates being received in response to the one or more authentication requests, to determine an authenticity status of each of the one or more available wireless network access points. The apparatus is additionally caused to cause, at least in part, a list of the one or more available wireless network access points and the authenticity status of each of the one or more available wireless network access points to be displayed.

Exemplary embodiments are described herein. It is envisioned, however, that any system that incorporates features of any apparatus, method and/or system described herein are encompassed by the scope and spirit of the exemplary embodiments.

### BRIEF DESCRIPTION OF THE DRAWINGS

The embodiments are illustrated by way of example, and not by way of limitation, in the figures of the accompanying drawings:

FIG. 1 is a diagram of a system capable of determining the authenticity of an available wireless network access point, according to one embodiment;

FIG. 2 is a diagram of the components of an authenticity determination platform, according to one embodiment;

FIG. 3 is a flowchart of a process for determining the authenticity of an available wireless network access point, according to one embodiment;

FIG. 4 is a diagram of a user interface utilized in the processes of FIG. 3, according to one embodiment; and

FIG. 5 is a diagram of a chip set that can be used to implement an embodiment.

### DESCRIPTION OF SOME EMBODIMENTS

Examples of a method, apparatus, and computer program for determining the authenticity of an available wireless network access point are disclosed. In the following description, for the purposes of explanation, numerous specific details are set forth in order to provide a thorough understanding of the embodiments. It is apparent, however, to one skilled in the art that the embodiments may be practiced without these specific details or with an equivalent arrangement. In other instances, well-known structures and devices are shown in block diagram form in order to avoid unnecessarily obscuring the embodiments.

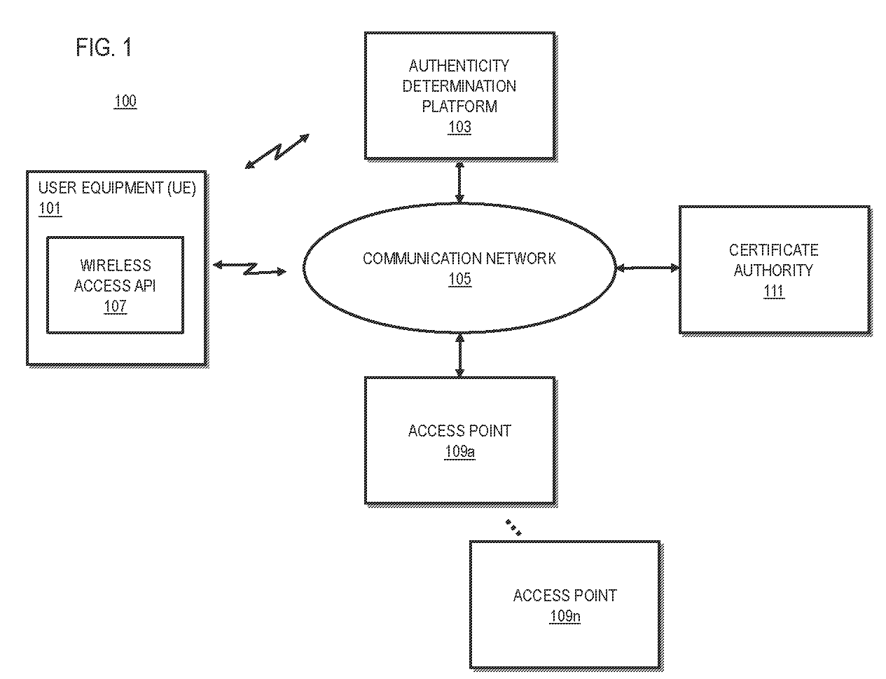

FIG. 1 is a diagram of a system capable of determining the authenticity of an available wireless network access point, according to one embodiment. Users of various mobile devices such as mobile phones, tablets, computers, etc. often access the internet using publicly accessible WiFi access points. Public wireless network access points are often associated with a name that may indicate a location or owner. Users often can only recognize a public wireless network access point by its name. However, it has become common practice for malicious individuals such as hackers to provide misleading access points to which an unsuspecting user may connect their device.

For example, if a particular store provides free public WiFi and identifies their access point using the name of the store, a hacker may provide an alternative access point either using the same name as the store, or something similar. The user has no way of knowing which available wireless network access point is the authentic access point and which is a malicious access point. If a user unsuspectingly connects their device to a malicious access point, any personal information that is stored or accessed by way of the device such as user names, passwords, bank account information, etc. may be vulnerable to attack by way of the malicious access point. For example, a hacker may capture and analyze a data packet that contains personal information with ease.

To address this problem, a system 100 of FIG. 1 introduces the capability to determine the authenticity of an available wireless network access point. The system 100 enables a user of a mobile device to recognize an available wireless network access point's security level or authenticity status through a graphical user interface. Wireless network access points that are authentic are registered with a certificate authority. Such authentic wireless network access points have an inherent degree of security compared to questionable wireless network access points whose authenticity cannot be verified with the certificate authority. By choosing to connect to only authentic available wireless network access points, a safer network environment for users of mobile devices may be created.

When searching for available wireless network access points, in some embodiments, a user may request that only authentic wireless network access points be presented as being available for connection based on a verification of their registration with the certificate authority. Such an option would further enhance the safety of a user's mobile device usage on public networks by not even providing the ability to connect a mobile device to a questionable network whose authenticity cannot be verified with the certificate authority.

As shown in FIG. 1, the system 100 comprises a user equipment (UE) 101 having connectivity to an authenticity determination platform 103, one or more wireless network access points 109a-109n (collectively referred to as wireless network access point 109), and a certificate authority 111 via a communication network 105. Though illustrated as being a remote entity from the UE 101, it should be noted that the authenticity determination platform 103 may alternatively, or additionally, be onboard the UE 101.

By way of example, though the system 100 is discussed as having connectivity to a WiFi access point for simplicity, the communication network 105 of system 100 may include one or more networks such as a wired data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), WiFi, WiGig, wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

According to various embodiments, the UE 101 may download one or more root certificates and/or certificate revocation lists (CRL) from the certificate authority 111. The UE 101 may accomplish this by way of one or more of the authenticity determination platform 103 and a wireless access application programming interface (API) 107 that the UE 101 may use to access a wireless network such as a network provided by an available wireless network access point 109. The wireless access API 107 and/or the authentication determination platform 103 may periodically update any root certificates and/or certificate revocation lists that it may cause to be stored in a memory of the UE 101 or stored in a memory accessible by the UE 101 to keep any downloaded root certificates and/or certificate revocation lists up to date.

Any wireless network access points 109 that desire to be authenticated may communicate with the certificate authority 111 so as to register the wireless network access point 109 with the certificate authority 111. Upon registration, the wireless network access point 109 sends a public key to the certificate authority 111 to request an access point certificate. The certificate authority 111, accordingly, encrypts the received public key with a certificate authority private key and issues an access point certificate to the requesting wireless network access point 109.

A UE 101 either having an existing network connection or needing connectivity to a wireless network for Internet access, for example, or some other wireless network access, may search for an available wireless network access point 109. The authenticity determination platform 103, by way of the wireless access API 107 may detect one or more available wireless network access points 109. Some available wireless network access points 109 may be authentic, others may be questionable. If questionable, this does not necessarily mean that the available wireless network access point 109 is malicious, misleading, or fake when compared to an authentic wireless network access point 109, but rather merely means that it cannot be verified as being an authentic wireless network access point 109, and accordingly could be malicious.

During the search for available wireless network access points, the authenticity determination platform 103 issues one or more authentication requests that are communicated to each of the one or more available wireless network access points 109. The authentication requests initiate a process by which a particular available wireless network access point 109 provides its access point certificate that the certificate authority 111 has provided to the wireless network access point 109. In some embodiments, the detection of any available wireless network access points 109 and the issuance of the one or more authentication requests may occur in a same period of time, while in other embodiments, the discovery process and the authentication requests may occur in succession.

Upon completion of any or all of the one or more authentication requests, as well as the wireless network access point discovery process, the authenticity determination platform 103 processes any received root certificates that the UE 101 may have downloaded or have access to, any certificate revocation lists that the UE 101 may have downloaded or have access to, and any access point certificates that may have been provided to the authenticity determination platform 103 by any available wireless network access points 109 in response to the one or more authentication requests to determine an authenticity status of each of the one or more available wireless network access points 109.

For example, the authenticity status of an available wireless network access point may be one of authentic or questionable. Questionable, as discussed above, may indicate that the corresponding available wireless network access point 109 may be malicious, or simply cannot be verified as being authentic.

In one or more embodiments, to determine authenticity, the authenticity determination platform 103 matches any received access point certificates with any received root certificates. The matching may be, for example, based on an association between the certificate authority private key associated with the one or more access point certificates and a received root certificate. As discussed above, the certificate authority private key and the access point certificate are provided by the certificate authority 111 when a public key is received from the a wireless network access point 109. The public key is encrypted with the certificate authority private key when the access point certificate is provided so that it is difficult, if not impossible, for a hacker or malicious user to replicate an authentic wireless network access point 109 so as to mislead a UE 101 and/or a user into connecting to the malicious wireless network access point.

In one or more embodiments, the authenticity determination platform 103 determines an available wireless network access point 109 is questionable if a received access point certificate is in a received certificate revocation list, any available wireless network access point 109 failed to provide a corresponding access point certificate in response to the authentication request, and/or a received access point certificate failed to match one or more of the received root certificates.

In some embodiments, the wireless access API 107, in response to an authenticity status determination by the authenticity determination platform 103 may generate a list of any available wireless network access points 109, as well as the authenticity status of each of the available wireless network access points 109. The list of available wireless network access points 109 and each respective authenticity status may be displayed by the wireless access API 107 in a graphical user interface (GUI), for example, or in a text format. The list of available wireless network access points 109 may include identification information such as the name and/or location of the available wireless network access points 109. The identification information may be received when the UE 101 searches for available wireless network access points 109.

In some embodiments, the wireless access API 107 may provide an option to hide the display of any wireless network access points that are determined to have a questionable authentication status. Such hiding of any potentially malicious or unverifiable wireless network access points 109 may provide a more secure network connection experience than a system 100 by which any public network may be unwittingly accessed.

By way of example, the UE 101, the authenticity determination platform 103, the wireless network access point 109, and the certificate authority 111 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

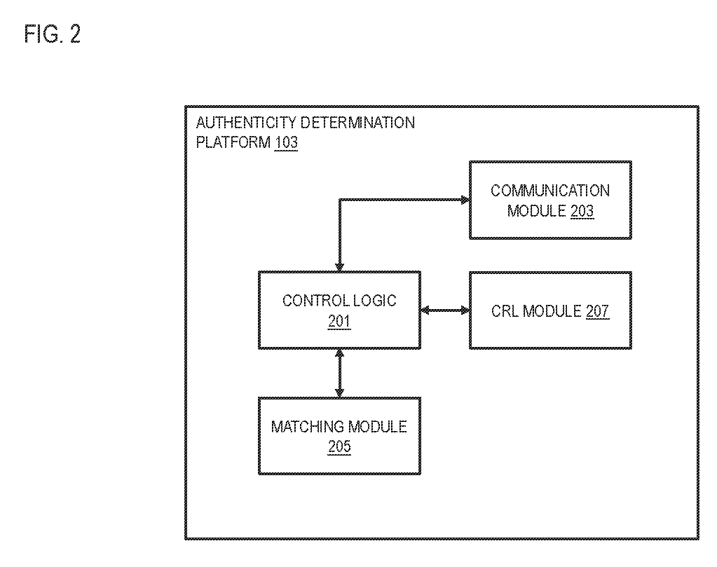

FIG. 2 is a diagram of the components of the authenticity determination platform 103, according to one embodiment. By way of example, the authenticity determination platform includes one or more components for providing determining the authenticity of an available wireless network access point. It is contemplated that the functions of these components may be combined in one or more components or performed by other components of equivalent functionality. In this embodiment, the authenticity determination platform includes a control logic 201, a communication module 203, a matching module 205, and a CRL module 207.

According to various embodiments, the control logic 201 instructs the communication module 203 to update any root certificates and/or certificate revocation lists that the UE 101 may have stored or have access to. The control logic 201, based on an instruction from the wireless access API 107, causes the communication module 203 to search for any available wireless network access points 109. The control logic 201 also issues an authentication request to any available wireless network access points 109 to provide its access point certificate to the authenticity determination platform 103. Once the discovery process and the authentication requests are complete, the control logic 201 instructs the matching module 205 to attempt to match any received access point certificates with any available root certificates.

Meanwhile, the control logic 201 also instructs the CRL module 207 to determine if any received access point certificates are in an available certificate revocation list. For example, if an access point certificate is in the certificate revocation list, the certificate authority 111 may have determined that corresponding wireless network access point 109 is malicious, or the certificate authority 111 may have revoked the access point certificate for the wireless network access point 109 for some other reason including, but not limited to, an expired access point certificate, or an inability of the wireless network access point 109 to update or refresh its registration with the certificate authority 111.

If any of the matching module 205 and the CRL module 207 determine that a received access point certificate cannot be matched to an available root certificate or is in an available certificate revocation list, the control logic instructs the communication module 203 to indicate to the wireless access API 107 that the authenticity of a particular available wireless network access point 109 could not be verified and is therefore of a questionable authentication status. Similarly, if the communication module 203 does not receive an access point certificate from any available wireless network access points 109, then the control logic 201 instructs the communication module 203 to indicate to the wireless access API 107 that the authenticity of a particular available wireless network access point 109 could not be verified and is therefore of a questionable authentication status.

Conversely, if the matching module 205 is able to match a received access point certificate to an available root certificate and the same received access point certificate is on in an available certificate revocation list, then the control logic 201 instructs the communication module 203 to indicate to the wireless access API 107 that the authenticity of a particular available wireless network access point 109 could be verified and is therefore of an authentic authentication status.

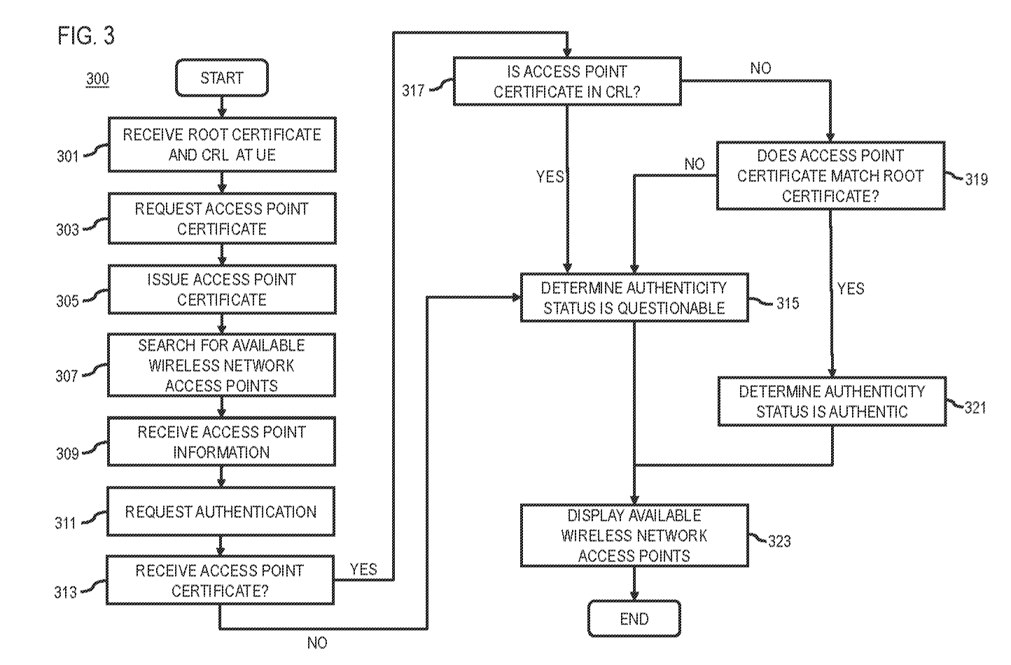

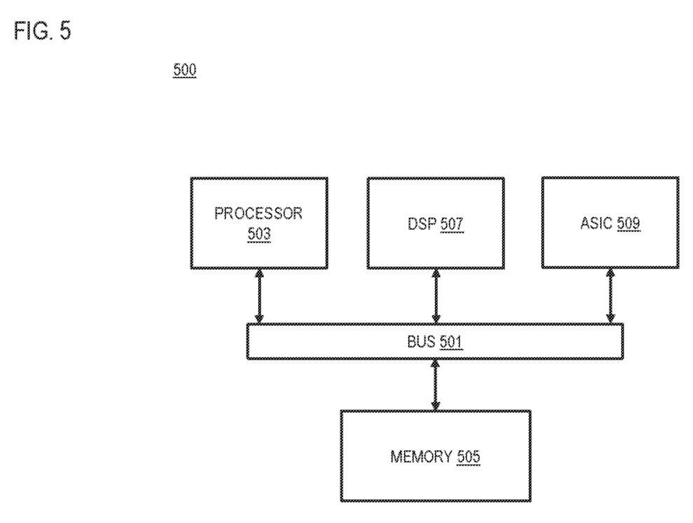

FIG. 3 is a flowchart of a process for determining the authenticity of an available wireless network access point, according to one embodiment. In one embodiment, the authenticity determination platform 103 performs the at least a part of process 300 and is implemented in, for instance, a chip set including a processor and a memory as shown in FIG. 5. In step 301, the authenticity determination platform 103 causes, at least in part, one or more root certificates and one or more certificate revocation lists to be received and stored by the UE 101 and/or the authenticity determination platform 103, or received and stored so that the root certificates and certificate revocation lists are available to the UE 101 and/or the authenticity determination platform 103. In step 303, an available wireless network access point 109 requests an access point certificate be provided to the requesting wireless network access point 109 by the certificate authority 111 in response to sending the certificate authority a public key that corresponds to the requesting wireless network access point. In step 305, the certificate authority 111 receives the public key from the requesting wireless network access point 109, encrypts the public key with a certificate authority private key, and issues the access point certificate.

The process continues to step 307 in which the authenticity determination platform 103 causes, at least in part, a detection of one or more available wireless network access points 109 in response, for example, to a search request made by the wireless access API 107. Then, in step 309, the authenticity determination platform 103 receives access point information from any detected available wireless network access points 109 such as, for example, a name and/or location or general description of a detected available wireless network access point 109.

Next, in step 311, the authenticity determination platform 103 causes, at least in part, one or more authentication requests to be communicated to each of the one or more available wireless network access points 109 requesting a corresponding access point certificate. In some embodiments, the detection of the one or more available wireless network access points 109 in step 307 and issuance of the one or more authentication requests in step 311 may occur in a same period of time or in sequence.

The process continues to step 313 in which the authenticity determination platform 103 determines if an access point certificate was received in response to the authentication request. If an access point certificate was not received, then the authenticity determination platform 103 assigns the detected available wireless network access point 109 a questionable authenticity status in step 315. If the authenticity determination platform 103 determines that an access point certificate was received from a detected available wireless network access point 109, then the process continues to step 317.

In step 317, the authenticity determination platform 103 determines if the received access point certificate is present in any received or available certificate revocation lists. If the access point certificate is in a certificate revocation list, the authenticity determination platform 103 assigns the detected available wireless network access point 109 a questionable authenticity status in step 315. However, if the access point certificate is not in a received certificate revocation list, the process continues to step 319.

In step 319, the authenticity determination platform 103 attempts to match any received access point certificates to an received or available root certificates. According to various embodiments, the matching is based, at least in part, on an association between a certificate authority private key associated with the one or more access point certificates and the received root certificate.

If an access point certificate cannot be matched to the root certificate, then the process continues to step 315 in which the authenticity determination platform 103 assigns the detected available wireless network access point 109 a questionable authenticity status in step 315. But, if the access point certificate is matched to the root certificate, then the authenticity determination platform 103 assigned the corresponding available wireless network access point 109 an authentic authenticity status in step 321.

The process then continues to step 323 in which the authenticity determination platform 103 communicates any authenticity statuses to the wireless access API 107 for display. The wireless access API 107 also, accordingly, is caused to display any received wireless network access point information. In some embodiments, as discussed above, the wireless access API 107 may be a graphical user interface that provides an option to hide the display of any wireless network access points 109 that are determined to have a questionable authentication status.

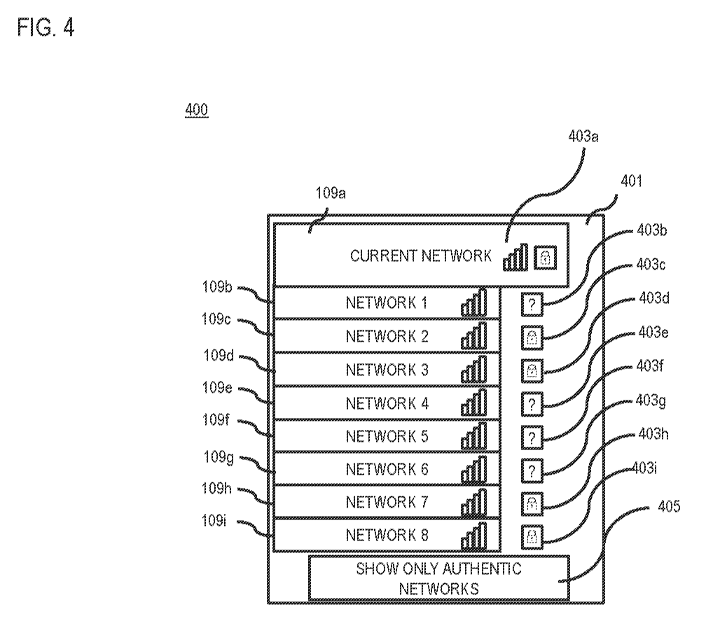

FIG. 4 is a diagram of an example user interface 400 utilized in the processes of FIG. 3, according to various embodiments. User interface 400 of wireless access API 107, discussed above, includes a list 401 of available wireless network access points 109b-109i, as well as a current wireless network access point 109a. The list 401 also includes authentication status indicators 403a-403i that illustrate whether an available wireless network access point 109 was determined to be authentic in the process 300, discussed above, or questionable. In this example, an authentic authenticity status is indicated by a lock icon while a questionable authenticity status is indicated by a question mark icon. These icons are merely exemplary and the authenticity status may be illustrated by any alternative forms such as, for example, various corresponding colors, words, other images, etc. The user interface 400 also includes, in this example, a hide questionable wireless network access points option 405. Though optionally included, the hide questionable wireless network access points option 405, when actuated, causes any questionable wireless network access points 109 to be hidden from the list 401 so that a UE 101 may not even have an option to connect to a questionable network. This option may be user controlled by way of the user interface 400 as illustrated. Alternatively, in other embodiments, the option may be a setting for the wireless access API 107 that may not be easily manipulated by way of the user interface 400 so as to enhance security. For example, the option for hiding questionable available wireless network access points may be a default setting that is not shown on the user interface 400, but rather is available for manipulation in some other interface associated with the wireless access API 107.

The processes described herein for determining the authenticity of an available wireless network access point may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

FIG. 5 illustrates a chip set or chip 500 upon which an embodiment may be implemented. Chip set 500 is programmed to determine the authenticity of an available wireless network access point as described herein may include, for example, bus 501, processor 503, memory 505, DSP 507 and ASIC 509 components.

The processor 503 and memory 505 may be incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 500 can be implemented in a single chip. It is further contemplated that in certain embodiments the chip set or chip 500 can be implemented as a single “system on a chip.” It is further contemplated that in certain embodiments a separate ASIC would not be used, for example, and that all relevant functions as disclosed herein would be performed by a processor or processors. Chip set or chip 500, or a portion thereof, constitutes a means for performing one or more steps of determining the authenticity of an available wireless network access point.

In one or more embodiments, the chip set or chip 500 includes a communication mechanism such as bus 501 for passing information among the components of the chip set 500. Processor 503 has connectivity to the bus 501 to execute instructions and process information stored in, for example, a memory 505. The processor 503 may include one or more processing cores with each core configured to perform independently. A multi-core processor enables multiprocessing within a single physical package. Examples of a multi-core processor include two, four, eight, or greater numbers of processing cores. Alternatively or in addition, the processor 503 may include one or more microprocessors configured in tandem via the bus 501 to enable independent execution of instructions, pipelining, and multithreading. The processor 503 may also be accompanied with one or more specialized components to perform certain processing functions and tasks such as one or more digital signal processors (DSP) 507, or one or more application-specific integrated circuits (ASIC) 509. A DSP 507 typically is configured to process real-world signals (e.g., sound) in real time independently of the processor 503. Similarly, an ASIC 509 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one or more embodiments, the processor (or multiple processors) 503 performs a set of operations on information as specified by computer program code related to determining the authenticity of an available wireless network access point. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 501 and placing information on the bus 501. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 503, such as a sequence of operation codes, constitute processor instructions, also called computer system instructions or, simply, computer instructions. Processors may be implemented as mechanical, electrical, magnetic, optical, chemical or quantum components, among others, alone or in combination.

The processor 503 and accompanying components have connectivity to the memory 505 via the bus 501. The memory 505 may include one or more of dynamic memory (e.g., RAM, magnetic disk, writable optical disk, etc.) and static memory (e.g., ROM, CD-ROM, etc.) for storing executable instructions that when executed perform the inventive steps described herein to determine the authenticity of an available wireless network access point. The memory 505 also stores the data associated with or generated by the execution of the inventive steps.

In one or more embodiments, the memory 505, such as a random access memory (RAM) or any other dynamic storage device, stores information including processor instructions for determining the authenticity of an available wireless network access point. Dynamic memory allows information stored therein to be changed by system 100. RAM allows a unit of information stored at a location called a memory address to be stored and retrieved independently of information at neighboring addresses. The memory 505 is also used by the processor 503 to store temporary values during execution of processor instructions. The memory 505 may also be a read only memory (ROM) or any other static storage device coupled to the bus 501 for storing static information, including instructions, that is not changed by the system 100. Some memory is composed of volatile storage that loses the information stored thereon when power is lost. The memory 505 may also be a non-volatile (persistent) storage device, such as a magnetic disk, optical disk or flash card, for storing information, including instructions, that persists even when the system 100 is turned off or otherwise loses power.

The term “computer-readable medium” as used herein refers to any medium that participates in providing information to processor 503, including instructions for execution. Such a medium may take many forms, including, but not limited to computer-readable storage medium (e.g., non-volatile media, volatile media), and transmission media. Non-volatile media includes, for example, optical or magnetic disks. Volatile media include, for example, dynamic memory. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

While a number of embodiments and implementations have been described, the disclosure is not so limited but covers various obvious modifications and equivalent arrangements, which fall within the purview of the appended claims. Although features of various embodiments are expressed in certain combinations among the claims, it is contemplated that these features can be arranged in any combination and order.

What is claimed is:

1. A method comprising:
causing, at least in part, a detection of one or more available wireless network access points;
causing, at least in part, one or more authentication requests to be communicated to each of the one or more available wireless network access points requesting a corresponding access point certificate;
processing one or more of one or more received root certificates, one or more received certificate revocation lists, and one or more received access point certificates, the one or more access point certificates being received in response to the one or more authentication requests, to determine an authenticity status of each of the one or more available wireless network access points;
causing, at least in part, a list of the one or more available wireless network access points and the authenticity status of each of the one or more available wireless network access points to be displayed.

2. A method of claim 1, wherein the authenticity status indicates an available wireless network access point is one of authentic or questionable.

3. A method of claim 2, wherein the authenticity status is determined to be authentic based, at least in part, on a matching of the received one or more access point certificates and the one or more received root certificates.

4. A method of claim 3, wherein the matching is based, at least in part, on an association between a certificate authority private key associated with the one or more access point certificates and the received root certificate, the certificate authority private key and the access point certificate being provided by a certificate authority based, at least in part, on a reception of a public key from the one or more available wireless network access points.

5. A method of claim 4, wherein the public key is encrypted with the certificate authority private key when the access point certificate is provided.

6. A method of claim 2, wherein the authenticity status is determined to be questionable based, at least in part, on one or more of a determination that a received access point certificate is in at least one of the one or more certificate revocation lists, a determination that an available wireless network access point failed to provide a corresponding access point certificate in response to the authentication request, and a received access point certificate failed to match one or more of the received root certificates.

7. A method of claim 2, further comprising:
causing, at least in part, an option to be provided to hide the display of one or more wireless network access points that are determined to have a questionable authentication status.

8. A method of claim 1, wherein the detection of the one or more available wireless network access points and the one or more authentication requests occur in a same period of time.

9. A method of claim 1, further comprising:
causing, at least in part, identification information of the one or more available wireless network access points to be received; and
causing, at least in part, the identification information of the one or more available wireless network access points to be displayed.

10. A method of claim 1, wherein the one or more root certificates and the one or more certificate revocation lists are received from a certificate authority.

11. An apparatus comprising:
at least one processor; and
at least one memory including computer program code for one or more programs,
the at least one memory and the computer program code configured to, with the at least one processor, cause the apparatus to perform at least the following,
cause, at least in part, a detection of one or more available wireless network access points;
cause, at least in part, one or more authentication requests to be communicated to each of the one or more available wireless network access points requesting a corresponding access point certificate;
process one or more of one or more received root certificates, one or more received certificate revocation lists, and one or more received access point certificates, the one or more access point certificates being received in response to the one or more authentication requests, to determine an authenticity status of each of the one or more available wireless network access points;
cause, at least in part, a list of the one or more available wireless network access points and the authenticity status of each of the one or more available wireless network access points to be displayed.

12. An apparatus of claim 11, wherein the authenticity status indicates an available wireless network access point is one of authentic or questionable.

13. An apparatus of claim 12, wherein the authenticity status is determined to be authentic based, at least in part, on a matching of the received one or more access point certificates and the one or more received root certificates.

14. An apparatus of claim 13, wherein the matching is based, at least in part, on an association between a certificate authority private key associated with the one or more access point certificates and the received root certificate, the certificate authority private key and the access point certificate being provided by a certificate authority based, at least in part, on a reception of a public key from the one or more available wireless network access points.

15. An apparatus of claim 14, wherein the public key is encrypted with the certificate authority private key when the access point certificate is provided.

16. An apparatus of claim 12, wherein the authenticity status is determined to be questionable based, at least in part, on one or more of a determination that a received access point certificate is in at least one of the one or more certificate revocation lists, a determination that an available wireless network access point failed to provide a corresponding access point certificate in response to the authentication request, and a received access point certificate failed to match one or more of the received root certificates.

17. An apparatus of claim 12, wherein the apparatus is further caused to:
causing, at least in part, an option to be provided to hide the display of one or more wireless network access points that are determined to have a questionable authentication status.

18. An apparatus of claim 11, wherein the detection of the one or more available wireless network access points and the one or more authentication requests occur in a same period of time.

19. An apparatus of claim 11, wherein the apparatus is further caused to:
causing, at least in part, identification information of the one or more available wireless network access points to be received; and
causing, at least in part, the identification information of the one or more available wireless network access points to be displayed.

20. An apparatus of claim 11, wherein the one or more root certificates and the one or more certificate revocation lists are received from a certificate authority.

21. A computer-readable storage medium carrying one or more sequences of one or more instructions which, when executed by one or more processors, cause an apparatus to at least perform the following:
cause, at least in part, a detection of one or more available wireless network access points;
cause, at least in part, one or more authentication requests to be communicated to each of the one or more available wireless network access points requesting a corresponding access point certificate;
process one or more of one or more received root certificates, one or more received certificate revocation lists, and one or more received access point certificates, the one or more access point certificates being received in response to the one or more authentication requests, to determine an authenticity status of each of the one or more available wireless network access points;
cause, at least in part, a list of the one or more available wireless network access points and the authenticity status of each of the one or more available wireless network access points to be displayed.

22. A computer-readable storage medium of claim 21, wherein the authenticity status indicates an available wireless network access point is one of authentic or questionable.
